(19) United States
(12) Patent Application Publication
(10) Pub. No.: US 2008/0189184 A1
(43) Pub. Date: Aug. 7, 2008

(54) MERCHANT SERVICE PORTAL APPLICATIONS INTERFACE SYSTEMS AND METHODS

(75) Inventors: Takayuki Kubo, Herrenberg (DE); Gerd Zinke, Berlin (DE); Norbert Albrecht, Berlin (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 11/670,023

(22) Filed: Feb. 1, 2007

(51) Int. Cl. G06Q 20/00

(52) U.S. Cl. 705/16

(57) ABSTRACT

Systems and methods are described to provide an interface between distinct host service providers and one or more remotely programmable point-of-sale devices. A set of transaction data may be received from a point-of-sale device. Different subsets of the set of transaction data may be identified for each of the service providers. Each of the identified subsets may be transmitted to the appropriate service provider in a format readable by that service provider.

### BACKGROUND OF THE INVENTION

This invention relates to the processing of point-of-sale transactions. More particularly, this invention relates to the interface between a point-of-sale device and hosts receiving and processing the transaction data.

In the sale of goods by a merchant to a customer, point-of-sale devices may be used by the merchant to process a transaction and communicate with financial service providers. For example, a scanner and credit card reader can be used to identify items purchased, tally an amount due, accept credit payments, and authorize the transaction. Point-of-sale devices may, therefore, be used to collect various types of data related to items purchased and payment methods, among other types of information. However, many point-of-sale devices are not configurable, and may be severely limited in the types of data that can be collected or in the flexibility to collect different types of data.

As noted above, when a purchase is made, different types of data may be collected about the items purchased and the financial transaction. Certain parts of the data may be applicable to only selected host systems (e.g., a payment host or a supply chain management host). However, the host systems may be operated by diverse entities, which may process data differently. Parsing the transaction data and routing it to the applicable host may present technical challenges under many existing systems.

It may, therefore, be desirable to have a flexible interface that can serve as an intermediary between configurable point-of-sale devices and diverse host systems.

### BRIEF SUMMARY OF THE INVENTION

Systems and methods are described which provide an interface between distinct host service providers and one or more remotely programmable point-of-sale devices. One set of transaction data may be received from a point-of-sale device. Different subsets of the set of transaction data may be identified for each of the host service providers. Each identified subset may be transmitted to the appropriate service provider in a format readable by that selected service provider.

In one set of embodiments, a system includes a point-of-sale device that is in communication with a server computer system. The point-of-sale device is configured to receive a set of configuration data from a remote source, the set of configuration data specifying a set of transaction data related to a transaction. The point-of-sale device is further configured to collect the transaction data for a particular transaction as specified by the set of configuration data. The set of configuration data may include one or more software applications. Therefore, the point-of-sale device may be set up to run the software applications to collect the set of transaction data, and further to transmit the collected transaction data as a single set of data.

The server computer system is configured to receive the collected set of transaction data. The server computer system is further configured to automatically generate different transaction messages, each message made up of a subset of the collected set of transaction data for a particular host service provider. The server computer system is configured to transmit the transaction messages. Part of the collected transaction data may be included in the different subsets, while part of the collected transaction data may be included in only certain messages.

In one embodiment, the various subsets of the transaction data may be in different formats, perhaps readable by only the distinct service provider to whom the message is directed. Moreover, the different transaction messages may be transmitted according to different communication protocols. The length of the transaction messages may vary depending upon the types of data collected and the configuration at the destination service provider.

In one embodiment, the point-of-sale device is configured to collect various different types of data related to a transaction, according to the received set of configuration data from the remote source. The point-of-sale device is configured to transmit sets of transaction of variable length depending, perhaps, on the types of data collected. The types of data to be collected may include bar code data, card reader data, PIN pad data, printer data, input data, location data, signature data, coupon data, loyalty data, itemized receipt data, time and date data, or any combination thereof.

The server computer system is, in one embodiment, configured to receive data identifying the part of the transaction data to be collected by the point-of-sale device for different service providers. The server computer system may be configured to consolidate this information to produce the set of configuration data. In this embodiment, the server computer system acts as the remote source. In another embodiment, the server computer system is configured to receive type information identifying the types of data to be transmitted to the distinct host service providers. The server computer system may then identify the subsets of collected transaction data based at least in part on the type information related to the distinct host service provider.

In one embodiment, the system includes the distinct host service providers that are in communication with the server computer system. One or more of them may be configured to transmit data to the server computer system, the data formatted to identify the subset of the collected set of transaction data for the particular host service provider. A particular host service provider may then receive a message with the subset of the collected transaction data which it identified. In another embodiment, the system includes the distinct host service providers that are in communication with the point-of-sale device, and configured to transmit to the point-of-sale device data identifying information to be collected by the point-of-sale device. A particular host service provider may then receive a message with the subset of the collected transaction data which it identified. The host service provider may, for example, be a payment host, a customer relationship management host, a supply chain management host, a loyalty host, or an accounting host.

In another set of embodiments, a system again includes a point-of-sale device in communication with a server computer system. The point-of-sale device is configured to collect a set of transaction data as set forth by one or more received sets of data, and transmit the collected set of transaction data. The point-of-sale device is in communication with the server computer system, which is configured to receive the collected set of transaction data.

The server computer system in this set of embodiments is configured to receive routing information identifying types to transaction data to be routed to selected host service providers of a plurality of host service providers. The server computer system automatically generates a number of transaction messages for a particular transaction, each of which is the subset of the collected set of transaction data for the distinct host service provider to which the transaction message is directed. The particular subset and distinct host service provider is identified via the routing information. Transaction messages are transmitted by the server computer system to the selected distinct host service providers.

In one embodiment, the system also includes the distinct host service providers that are in communication with the server computer system, and configured to transmit data identifying selected types of information to be collected by the point-of-sale device. The routing information includes this information from the distinct host service providers.

In yet another set of embodiments, a method for interfacing with a point-of-sale device is described. A set of configuration data is transmitted which specifies a set of transaction data to be collected by the point-of-sale device. The set of transaction data collected according to the configuration data is then received. A first transaction message is automatically generated for a first distinct host service provider, including a first subset of the collected set of transaction data. A second transaction message is automatically generated for a second distinct host service provider, including a second subset of the collected set of transaction data. At least a part of the set of transaction data is included in the first subset and the second subset. The first and second transaction messages are then transmitted.

In one embodiment, sets of data are received which each identify a part of the transaction data to be collected by the point-of-sale device. Information from the received sets is consolidated to produce the set of configuration data. For example, a first set of data identifying information to be collected by the point-of sale device for the first distinct host service provider may be received from the first distinct host service provider, and a second set of data identifying information to be collected by the point-of-sale device for the second distinct host service provider may be received from the second distinct host service provider. The subsets of the collected set of transaction data for each distinct service provider may be identified and transmitted based on the received first or second sets of data.

The first transaction message may be routed to the first distinct host service provider in a first format, and the second transaction message may be routed to the second distinct host service provider in a second format. Moreover, the first subset of the collected set of transaction data may be converted from the format of the data received from the point-of sale device to a different format. In such an embodiment, the first transaction message may encapsulate the received first subset in the different format.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram illustrating a system that includes an interface between a point-of-sale device and two distinct host service providers according to various embodiments of the invention.

FIG. 2 is a block diagram illustrating a system that includes an interface between a diverse point-of-sale devices and a number of distinct host service providers according to various embodiments of the invention.

FIGS. 3A-3D illustrate sets of transaction data formatted according to various embodiments of the invention.

FIG. 4 is a block diagram illustrating an alternative system configuration that includes an interface between a point-of-sale device and two distinct host service providers according to various embodiments of the invention.

FIGS. 5A-5C illustrate sets of XML transaction data formatted according to various embodiments of the invention.

FIG. 6 is a flow diagram illustrating a method for interfacing with a point-of-sale device.

FIG. 7 is a flow diagram illustrating an alternative method for interfacing with a point-of-sale device.

FIG. 8 is a schematic diagram that illustrates a representative device structure that may be used in various embodiments of the present invention.

### DETAILED DESCRIPTION OF THE INVENTION

This description provides exemplary embodiments only, and is not intended to limit the scope, applicability or configuration of the invention. Rather, the ensuing description of the embodiments will provide those skilled in the art with an enabling description for implementing embodiments of the invention. Various changes may be made in the function and arrangement of elements without departing from the spirit and scope of the invention as set forth in the appended claims.

Thus, various embodiments may omit, substitute, or add various procedures or components as appropriate. For instance, it should be appreciated that in alternative embodiments, the methods may be performed in an order different than that described, and that various steps may be added, omitted or combined. Also, features described with respect to certain embodiments may be combined in various other embodiments. Different aspects and elements of the embodiments may be combined in a similar manner.

It should also be appreciated that the following systems, methods, and software may be a component of a larger system, wherein other procedures may take precedence over or otherwise modify their application. Also, a number of steps may be required before, after, or concurrently with the following embodiments.

Systems and methods are described that provide an interface between distinct host service providers and one or more remotely programmable point-of-sale devices. One set of transaction data may be received from a point-of-sale device. Different subsets of the set of transaction data may be identified for each of the service providers. Each identified subset may be transmitted to the selected service provider in a format readable by that selected service provider.

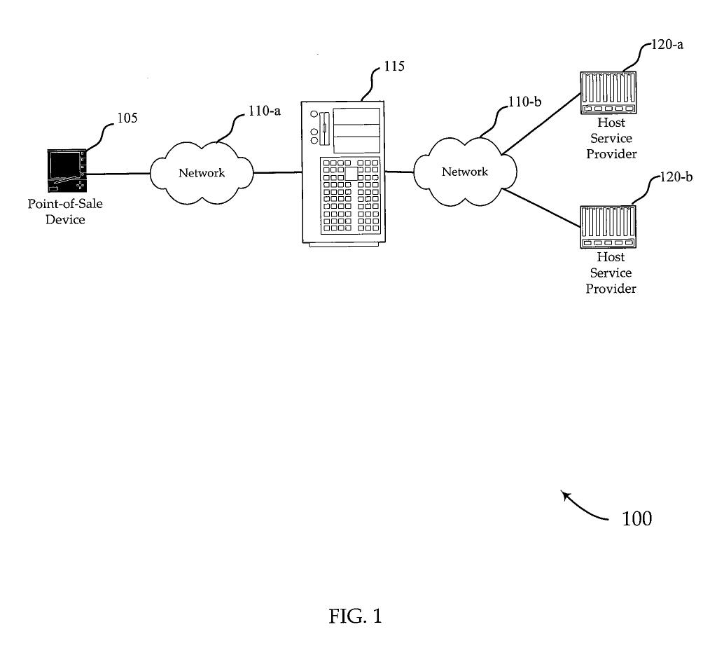

Referring to FIG. 1, a system 100 is illustrated that provides an interface between two or more distinct host service providers 120 and a point-of-sale device 105. In one embodiment, the system includes a point-of-sale device 105, a server computer system 115, and two distinct host service providers 120.

The point-of-sale device 105 may be any electronic device or terminal that may be programmed or otherwise used to process transactions. Such a device 105 may be a terminal, device or system that has been programmed and certified to the specifications of particular networks (e.g., ATM/debit, point-of-sale or check processor networks) in order to be able to process merchant or online transactions using credit cards, stored-value cards, or other presentation instruments. The point-of-sale device 105 may collect the types transaction data specified by one or more received sets of data (which may be referred to herein as configuration data), and transmit the collected set of transaction data. A point-of-sale device 105 may also include, for example, a web site of a merchant where similar transaction data may be collected, a MOTO merchant environment, a cardholder activated terminal, or a contactless terminal (such as multi-lane terminals). In one embodiment, the point-of-device 105 is a thin client device that downloads applications or other software from a server computer system 115. The applications or other software may be run on the point-of-sale device 105 to identify the transaction information to be collected. The applications may be configured to collect different transaction data depending on the type of presentation instrument used, the financial institution involved, the merchant category, and the demographics of the purchaser.

In one embodiment, the point-of-sale 105 device is configured to receive a set of configuration data from other remote sources as well. Thus, regardless of the source, a set of configuration data may be received which specifies a set of transaction data to be collected by the point-of-sale device 105, and configures or otherwise programs the point-of sale-device 105 accordingly. The point-of-sale device 105 may be configured to transmit the collected transaction data as a single set of data, even if the collected set of data is destined for different host service providers 120. For example, instead of transmitting different sets of data for each distinct host service provider 120, the point-of-sale device 105 may transmit a single set of information to be divided downstream into various subsets for the different hosts 120. This may reduce traffic between the point-of-sale device 105 and the server computer system 115. The set of transaction data may be of different lengths, depending on the amount and type of data collected.

The point-of-sale device 105 may be in communication with the server computer system 115 via network 110-a. A network 110 may be any combination of the following: the Internet, an intranet, a wide-area network (“WAN”), a local-area network (“LAN”), a virtual private network, the Public Switched Telephone Network (“PSTN”), or any other type of network supporting communication between devices described herein, in different embodiments. The network 110 may include both wired and wireless connections, including optical links. Many other examples are possible and apparent to those skilled in the art in light of this disclosure. In the discussion that follows, a network 110 may or may not be noted specifically. If no specific means of connection is noted, it may be assumed that the link, communication or other connection between devices may be via a network 110.

The server computer system 115 may be fully located within a single facility or distributed geographically, in which case a network 110 may be used to integrate different components of the server computer system 115. The server computer system 115 may also include one or more databases, or have other memory. Configuration data for the point-of-sale device 105 may be stored by the server computer system 115, and transmitted to the point-of-sale device 105. The server computer system 115 may receive data identifying the transaction data to be collected by the point-of-sale device 105 for different service providers 120. The server computer system 115 may consolidate this information to produce the set of configuration data. In another embodiment, the server computer system 115 receives type information identifying the types of data to be collected by the point-of-sale device 105, and consolidates and transmits the type information to the point-of-sale device 105.

The configuration data may include applications to run on the point-of-sale device 105 and collect various types of data related to different transactions (e.g., bar code data, card reader data, PIN pad data, printer data, input data, location data, signature data, coupon data, loyalty data, itemized receipt data, time and date data, or any combination thereof). The type of data to be collected may, for example, depend on host service provider preferences, card holder preferences or demographics, financial institution preferences, merchant profiles, transaction types, or other factors.

The server computer system 115 may also be configured to receive the collected set of transaction data from the point-of-sale device 105. The server computer system 115 may use the configuration data (e.g., type information) to identify and divide a subset of the data for a distinct host service provider 120. The server computer system 115 may automatically generate different transaction messages, each message made up of an identified subset of the collected set of transaction data for a particular host service provider 120. The server computer system 115 may transmit the transaction messages. In one embodiment, a part of the collected transaction data is included two or more different subsets, while another part of the collected transaction data may be included in only one selected subset.

In one embodiment, the various subsets of the transaction data may be in different formats (e.g., various XML based messaging formats, other standards based financial formats, proprietary formats, etc.), readable by (perhaps only) the distinct service provider to whom the message is directed. The set of transaction data itself may be converted (e.g., by the server computer system 115) from the format in which it is received from the point-of-sale device to a different data format. Moreover, the different transaction messages may be transmitted according to different communication protocols (e.g., different network layer, data link layer, or physical layer messages). The length of the transaction messages may vary depending upon the types of data collected and the configurations at the destination host service provider.

The server computer system 115 is, in one embodiment, configured to receive data identifying the part(s) of the transaction data collected by the point-of-sale device 105 which are to be transmitted to different service providers. The server computer system 115 may be configured to consolidate this information to produce the set of configuration data. In another embodiment, the server computer system 115 is configured to receive type information identifying the types of data to be transmitted to particular distinct host service providers. The type information may be included in routing information, allowing the server computer system to identify, divide and route particular types of information accordingly. The server computer system 115 may, therefore, identify the subsets of collected transaction data based at least in part on the received type information or routing information related to a particular host service provider.

In one embodiment, the system 100 includes a number of distinct host service providers 120, in communication with the server computer system 115 via a network 110-b. One or more of host service providers 120 may be configured to transmit data to the server computer system 115, which identifies the subset of the collected set of transaction data to be collected for a particular provider (e.g., host service provider 120-a). This identification data may be processed by the server computer system 115 to create configuration data to download to the point-of-sale device 105. The particular provider 120-a may then receive a transaction message from the server computer system 115 with the subset of the collected transaction data which it identified. The distinct host service providers 120 may, for example, be different payment hosts, customer relationship management hosts, supply chain management hosts, loyalty hosts, accounting hosts, tax hosts, or other host service providers. The service providers may, for example, perform services related to traceability of transactions, coupon processing, itemized receipts, marketing, electronic receipts, signature capture, etc. Distinct host service providers 120 are owned or operated by different entities or corporations. Host service providers may be distinct even if there is some level of common ownership.

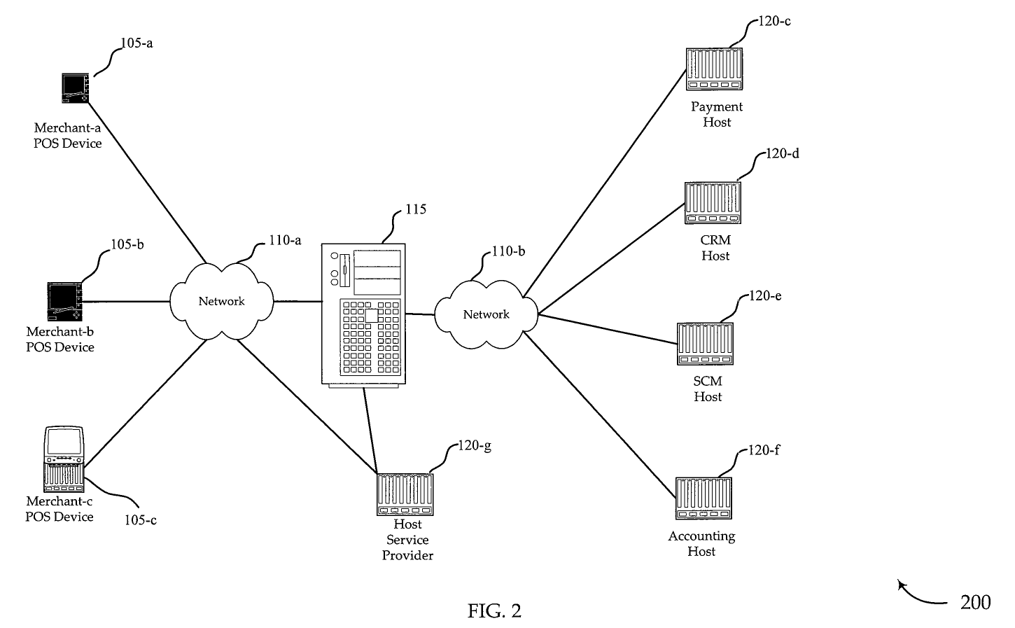

Referring to FIG. 2, a system 200 is illustrated that provides an interface between a number of distinct host service providers 120 and a variety of point-of-sale devices 105. In one embodiment, parts of system 200 of FIG. 2 are implemented as the system 100 depicted in FIG. 1. The system 200 of FIG. 2 includes a point-of-sale device 105-a of a first type at merchant-a, point-of-sale device 105-b of a second type at merchant-b, and a point-of-sale device 105-c of a third type at merchant-c. The system 200 further includes a server computer system 115 in communication with each point-of-sale device 105. Also, the system 200 includes a payment host 120-c, a customer relationship management (“CRM”) host 120-d, a supply chain management (“SCM”) host 120-e, an accounting host 120-f, and another host service provider 120-g, each in communication with the server computer system 115.

By way of example, one or more of the payment host 120-c, CRM host 120-d, SCM host 120-e, and accounting host 120-f may transmit a message or other data to the server computer system 115 with information on the types of data to be collected for the respective provider. The server computer system 115 may consolidate this information and transmit the consolidated information to the diverse point-of-sale devices 105 (or a subset thereof) as configuration data. It is also worth noting that configuration data may be transmitted to point-of-sale device without being routed through the server computer system (e.g., from host service provider 120-g to merchant-c point-of-sale device 105-c).

The diverse point-of-sale devices 105 (or a subset thereof) may then collect data related to a transaction according to the received configuration data. Each point-of-sale device 105 may transmit a single set of transaction data related to a particular transaction to the server computer system 115, which may automatically divide the received set of transaction data into subsets for transaction messages to be transmitted to respective host service providers.

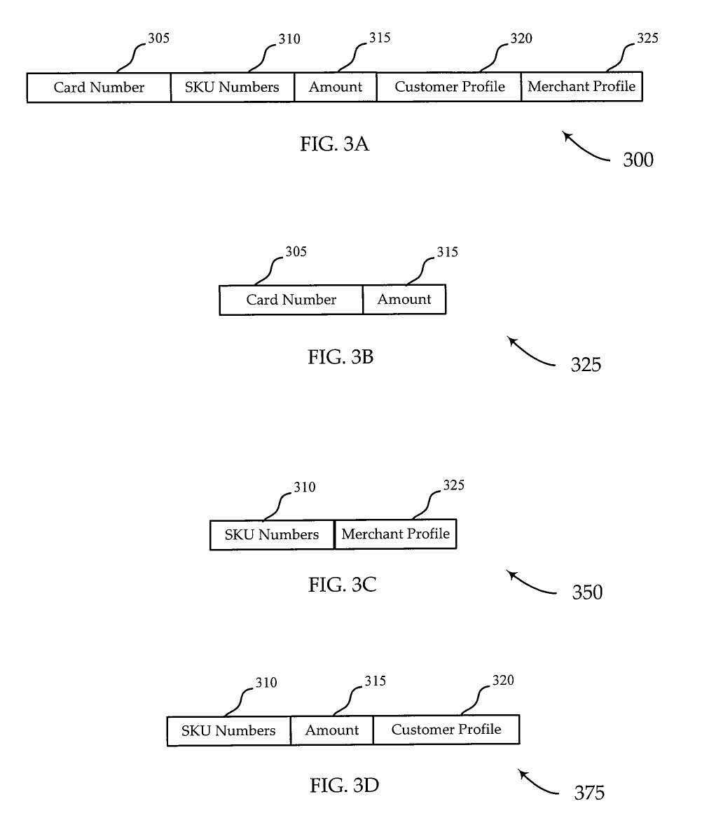

An example of this functionality is illustrated with reference to FIGS. 3A-3D. The sets of data illustrated in FIGS. 3A-3D may be transmitted in the system 200 of FIG. 2, in the manner described below. Referring first to FIG. 3A, a single set of transaction data 300 is shown. This set of transaction data 300 may, for example, be encapsulated by merchant-b point-of-sale device 105-b and transmitted to the server computer system 115 in the system 200 of FIG. 2. This set of transaction data 300 includes a card number 305, SKU numbers 310, an amount 315, a customer profile 320, and a merchant profile 325. In other embodiments, different types of transaction data may be collected, as the point-of-sale device is remotely configurable. The point-of-sale device 105-b may collect the transaction data 300 according to received configuration data (perhaps in the form of software applications downloaded from the server computer system 115).

Upon receiving the set of transaction data 300, the server computer system 115 may store the data on a temporary (or more permanent) basis. The server computer system 115 may divide or otherwise copy part of the data for respective host service provider (e.g., by copying the relevant parts of stored set of transaction data). In certain embodiments, the server computer system may consolidate information for particular host service providers, and only transmit the accumulated data on a periodic basis (e.g., every 10 transactions, or every day). However, for purposes of the discussion herein, assume that the data is forwarded for each transaction.

Referring to FIG. 3B, the server computer system 115 may recognize that payment host 120-c will only receive the card number and amount information for a given transaction. Thus, the server computer system 115 may identify the card number 305 and amount 315 information within the set of transaction data 300, and copy or otherwise parse that data to create the transaction message payload 325 to be transmitted to the payment host 120-c.

Referring to FIG. 3C, the server computer system 115 may recognize that SCM host 120-e will only receive the SKU numbers and merchant profile for a given transaction. Thus, the server computer system 115 may identify the SKU numbers 310 and merchant profile 325 information within the set of transaction data 300, and copy or otherwise parse that data to create the transaction message payload 350 to be transmitted to the SCM host 120-e. Note that the server computer system 115 may convert the format of the received transaction data 300 to a different format for transaction message payload 350, adapted to the specifications of the SCM host 120-e.

Referring to FIG. 3D, the server computer system 115 may recognize that CRM host 120-d will only receive the SKU numbers, amount, and customer profile for a given transaction. Thus, the server computer system 115 may identify the SKU numbers 310, amount 315, and customer profile 320 information within the set of transaction data 300, and copy or otherwise parse that data to create the transaction message payload 375 to be transmitted to the CRM host 120-d. Note that the server computer system 115 may be configured to transmit transaction messages of different sizes and according to different communication protocols.

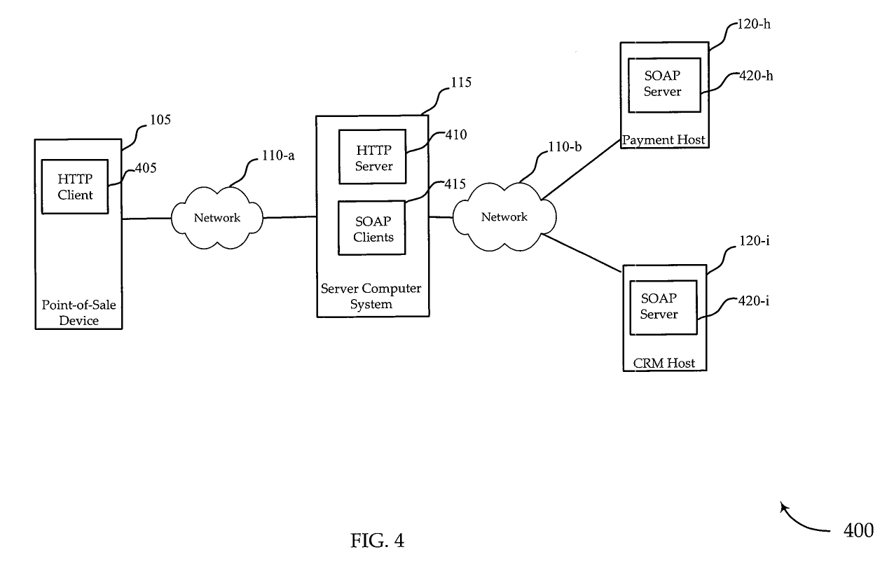

Referring to FIG. 4, a system 400 is illustrated that provides an example implementation of an interface between two or more distinct host service providers 120 and a point-of-sale device 105. This system 400 may be implemented as the system 100 described with reference to FIG. 1. In one embodiment, the system 400 again includes a point-of-sale device 105, a server computer system 115, and two distinct host service providers 120.

In this system 400, an operating system at the point-of-sale device 105 may collect a set of transaction data for a transaction. The operating system for the point-of-sale device 105 may run applications downloaded from the server computer system 115 to collect the transaction information relevant to particular host service providers 120. An HTTP client module 405 at the point-of-sale device 105 may generate a session with an HTTP server 410 at the server computer system (Note that where HTTP protocol is specified herein, HTTPS may be used as well). The HTTP client module may send the collected set of transaction data via the session to the common gateway interface (CGI), which in this embodiment is a set of simple object access protocol (SOAP) clients 415 (Note that where CGI is specified herein, JSP, ASP, PHP, Perl and other techniques may be used to perform similar functions).

The SOAP client modules may automatically generate messages for SOAP servers 420 at the host service providers 120 (which, in this embodiment, include a payment host 120-h and a CRM host 120-i). The SOAP server 420-h at the payment host 120-h and the SOAP server 420-i at the CRM host 120-i may process payment data and CRM data, respectively, and return responses to the server computer system 115. SOAP client modules 415 at the server computer system 115 may process the received response, and then transmit them via the HTTP server 410 to the HTTP client 405 at the point-of-sale device 105. Although HTTP communication is described above, SMTP, FTP, RPC, or other protocols may be used, as well.

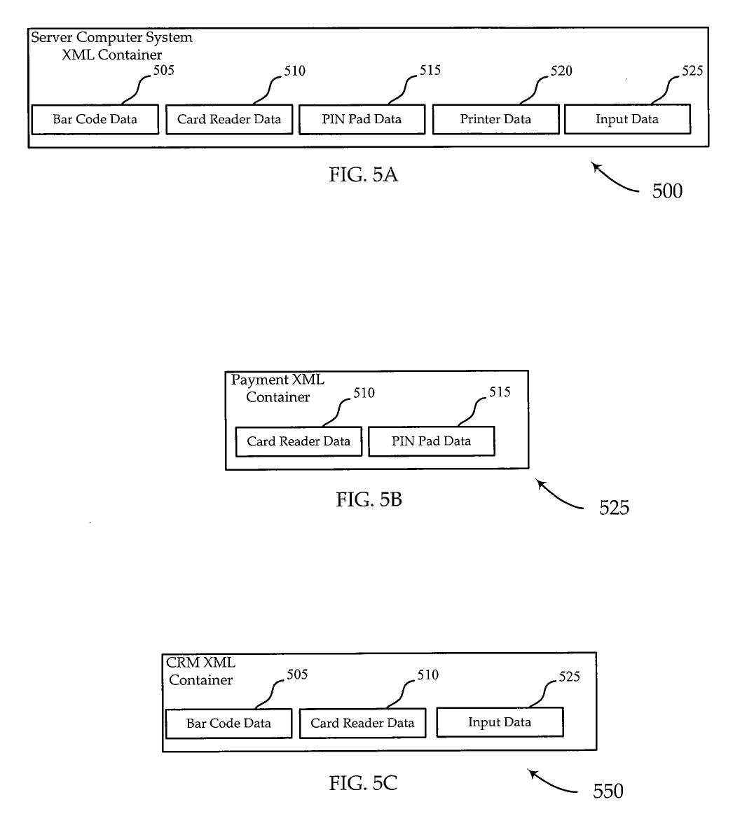

An example of the functionality described for the system 400 of FIG. 4 is illustrated with reference to FIGS. 5A-5C. Referring first to FIG. 5A, a single set of transaction data is shown, contained in a server computer system XML container 500. This set of transaction data may for example, be encapsulated by the point-of-sale device 105 and transmitted to the server computer system 115 in the system 400 of FIG. 4. This set of transaction data in the server computer system XML container 500 includes bar code data 505, card reader data 510, PIN pad data 515, printer data 520, and input data 525. The point-of-sale device 105 may collect the transaction data 300 according to configuration data (perhaps in the form of message from the host service providers 120 via the server computer system 115).

Referring to FIG. 5B, the SOAP clients 415 at the server computer system 115 may open the server computer system XML container 500, interpret the meaning of the data, and then make combinations of the data. For example, the SOAP clients 415 may recognize that payment host 420-h receives card reader data and PIN pad data for a given transaction. Thus, the SOAP clients 415 may identify the card reader data 510 and PIN pad data 515 within the set of transaction data of the server computer system XML container 500, and copy or otherwise parse that data to create the transaction message payload for the payment XML container 525 to be transmitted to the payment host 420-h. Security may, for example, be implemented by encrypting both the XML container 500 and the PIN pad data separately.

Similarly, referring to FIG. 5C, the SOAP clients 415 may recognize that CRM host 420-i receives bar code data, card reader data, and input data for a given transaction. Thus, the SOAP clients 415 may identify bar code data 505, card reader data 510, and input data 525 within the set of transaction data of the server computer system XML container 500, and copy or otherwise parse that data to create the transaction message payload for the CRM XML container 550 to be transmitted to the CRM host 420-i.

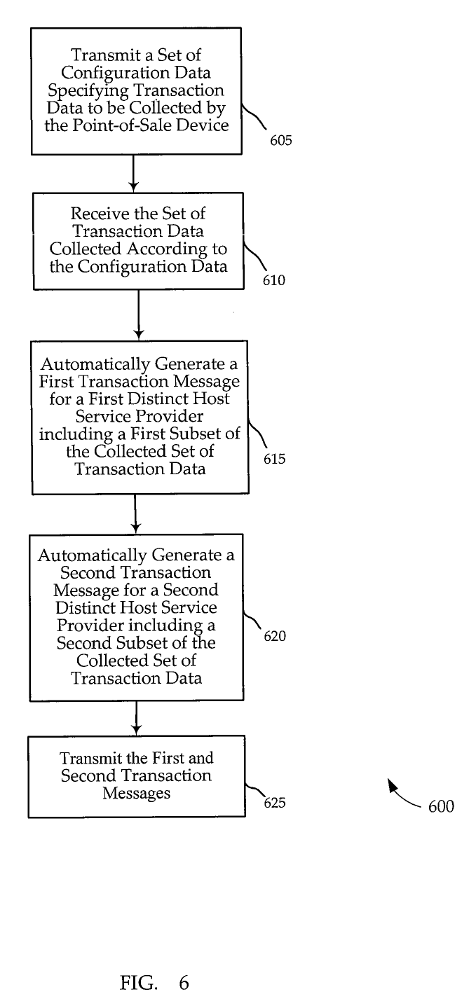

Referring next to FIG. 6, a flow diagram illustrating a method 600 for interfacing with a point-of-sale device is described, according to one embodiment of the invention. This method 600 may, for example, be performed by the server computer system 115 of FIG. 1. At block 605, a set of configuration data is transmitted which specifies a set of transaction data to be collected by the point-of-sale device. At block 610, the set of transaction data collected according to the configuration data is then received. At block 615, a first transaction message is automatically generated for a first distinct host service provider, including a first subset of the collected set of transaction data. At block 620, a second transaction message is automatically generated for a second distinct host service provider, including a second subset of the collected set of transaction data. At least a part of the set of transaction data may be included in the first subset and the second subset. At block 625, the first and second transaction messages are then transmitted.

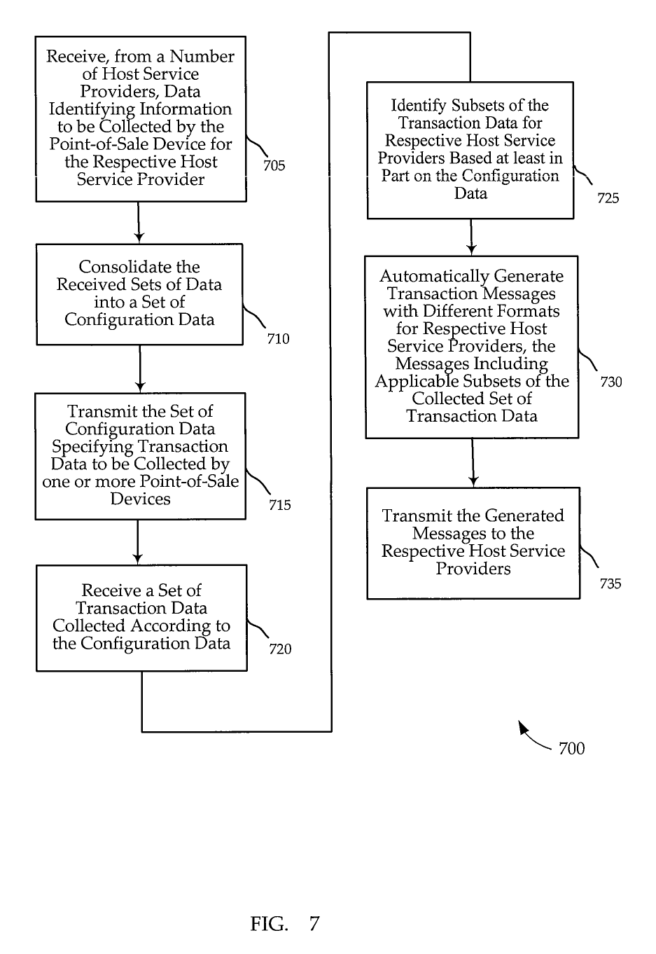

FIG. 7 is a flow diagram illustrating an alternative method 700 for interfacing with a point-of-sale device according to one embodiment of the invention. This method may, for example, be performed by the server computer system 115 of FIG. 1. At block 705, data identifying information to be collected by the point-of-sale device for host service providers is received from the respective host service providers. At block 710, the received sets of data are consolidated into a set of configuration data. At block 715, the set of configuration data specifying transaction data to be collected is transmitted to the one or more point-of-sale devices.

At block 720, a set of transaction data collected according to the configuration data is received from a point-of-sale device. At block 725, subsets of the transaction data for respective host service providers are identified based at least in part on the configuration data. At block 730, transaction messages with different formats are automatically generated for respective host service providers, the messages including applicable subsets of the collected set of transaction data. At block 735, the generated messages are transmitted to the respective host service providers.

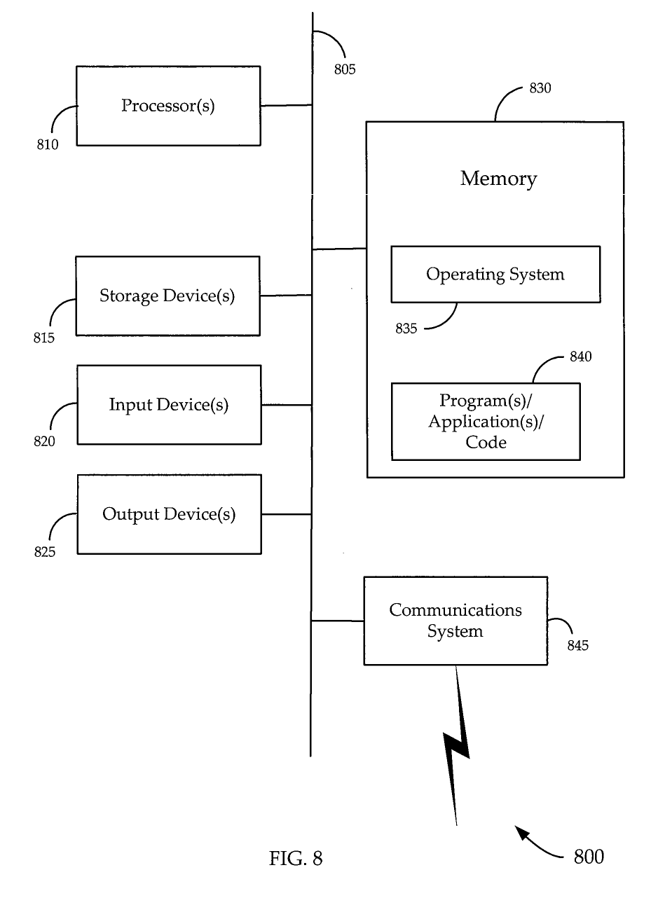

A device structure 800 that may be used for a point-of-sale device 105, server computer system 115, host service provider 120, or other computing device described herein is illustrated with the schematic diagram of FIG. 8. This drawing broadly illustrates how individual system elements of each of the aforementioned devices may be implemented, whether in a separated or more integrated manner. The exemplary structure is shown comprised of hardware elements that are electrically coupled via bus 805, including processor(s) 810 (which may further comprise a DSP or special-purpose processor), storage device(s) 815, input device(s) 820, and output device(s) 825. The storage device(s) 815 may be a computer-readable storage media reader connected to any computer-readable storage medium, the combination comprehensively representing remote, local, fixed, or removable storage devices or storage media for temporarily or more permanently containing computer-readable information. The communications system 845 may be a wired, wireless, or other type of interfacing connection that permits data to be exchanged with or received from other devices (e.g., two-way communication and receiving location data). The communications system(s) 845 may permit data to be exchanged with a network (including, without limitation, the network 110).

The structure 800 may also include additional software elements, shown as being currently located within working memory 830, including an operating system 835 and other code 840, such as programs or applications designed to implement methods of the invention. It will be apparent to those skilled in the art that substantial variations may be used in accordance with specific requirements. For example, customized hardware might also be used, or particular elements might be implemented in hardware, software (including portable software, such as applets), or both.

It should be noted that the methods, systems and devices discussed above are intended merely to be exemplary in nature. It must be stressed that various embodiments may omit, substitute, or add various procedures or components as appropriate. For instance, it should be appreciated that in alternative embodiments, the methods may be performed in an order different than that described, and that various steps may be added, omitted or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow chart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure.

Moreover, as disclosed herein, the terms “storage medium” or “storage device” may represent one or more devices for storing data, including read only memory (ROM), random access memory (RAM), magnetic RAM, core memory, magnetic disk storage mediums, optical storage mediums, flash memory devices or other machine readable mediums for storing information. The term “machine readable medium” includes, but is not limited to, portable or fixed storage devices, optical storage devices, wireless channels, a sim card, other smart cards, and various other mediums capable of storing, containing or carrying instructions or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be required before the above elements are considered. Accordingly, the above description should not be taken as limiting the scope of the invention, which is defined in the following claims.

What is claimed is:

1. A system comprising:
a point-of-sale device configured to:
receive a set of configuration data from a remote source, the set of configuration data specifying a set of transaction data related to a transaction to be collected by the point-of-sale device;
collect the set of transaction data for a particular transaction as specified by the set of configuration data; and
transmit the collected set of transaction data as a single set of data;
a server computer system, communicatively coupled with the point-of-sale device, and configured to:
receive the collected set of transaction data;
automatically generate a first transaction message comprising a first subset of the collected set of transaction data for a first distinct host service provider;
automatically generate a second transaction message comprising a second subset of the collected set of transaction data for a second distinct host service provider; and
transmit the first and second transaction messages.

2. The system of claim 1, wherein,
at least a part of the collected transaction data is included both in the first subset of the collected set of transaction data and in the second subset of the collected set of transaction data; and
at least a part of the collected transaction data is included in the first subset of the collected set of transaction data and not included in the second subset of the collected set of transaction data.

3. The system of claim 1, wherein the server computer system is further configured to:
identify data for the first subset from the collected set of transaction data and convert it into a first format readable by the first distinct host service provider; and
identify data for the second subset from the collected set of transaction data and convert it into a second format readable by the second distinct host service provider.

4. The system of claim 1, wherein the server computer system is further configured to:
transmit the first transaction message according to a first communication protocol; and
transmit the second transaction message according to a second communication protocol.

5. The system of claim 1, wherein the point-of-sale device is configured to collect different types of transaction data according to the set of configuration data.

6. The system of claim 1, wherein the server computer system is further configured to:
generate the first transaction message in a first length; and
generate the second transaction message in a second length,
wherein a length of a transaction message is variable depending upon the types of data collected in the first and the second transaction messages.

7. The system of claim 1, wherein,
the point-of-sale device is configured to transmit the collected set of transaction data in variable lengths.

8. The system of claim 1, wherein,
the server computer system is further configured to:
receive a plurality of sets of data each identifying a part of the transaction data to be collected by the point-of-sale device; and
consolidate information from the received sets to produce the set of configuration data; and
the server computer system comprises the remote source.

9. The system of claim 1, wherein the server computer system is further configured to:
receive type information identifying the types of data to be transmitted to the first and the second distinct host service providers;
identify the first subset from the collected set of transaction data based at least in part on the type information related to the first distinct host service provider; and
identify the second subset from the collected set of transaction data based at least in part on the type information related to the second distinct host service provider.

10. The system of claim 1, further comprising:
the first distinct host service provider, communicatively coupled with the server computer system, and configured to:
transmit a first set of data to the server computer system formatted to identify the first subset of the collected set of transaction data; and
receive the first message including the first subset of the collected set of transaction data;
the second distinct host service provider, communicatively coupled with the server computer system, and configured to:
transmit a second set of data to the server computer system formatted to identify the second subset of the collected set of transaction data; and
receive the second message including the second subset of the collected set of transaction data,
wherein the set of configuration data comprises the first set of data and the second set of data.

11. The system of claim 1, further comprising:
the first distinct host service provider, communicatively coupled with the point-of-sale device, and configured to:
transmit to the point-of-sale device a first set of data identifying information to be collected by the point-of-sale device; and
receive the first message including the first subset of the collected set of transaction data,
wherein the first set of data identifies the first subset of the collected set of transaction data.

12. The system of claim 11, wherein the first distinct host service provider or the second distinct host service provider comprises a payment host, a customer relationship management host, a supply chain management host, a loyalty host, or an accounting host.

13. The system of claim 1, wherein the collected set of transaction data comprises bar code data, card reader data, PIN pad data, printer data, input data, location data, signature data, coupon data, loyalty data, itemized receipt data, time and date data, or any combination thereof.

14. The system of claim 1, wherein,
the set of configuration data includes a plurality of software applications; and
the point-of-sale device is further configured to run the plurality of software applications to collect the set of transaction data.

15. A method comprising:
transmitting a set of configuration data specifying a set of transaction data related to a transaction to be collected by a point-of-sale device;
receiving the set of transaction data collected according to the configuration data;
automatically generating a first transaction message for a first distinct host service provider including a first subset of the collected set of transaction data;
automatically generating a second transaction message for a second distinct host service provider including a second subset of the collected set of transaction data; and
transmitting the first and second transaction messages,
wherein a part of the set of transaction data is included in the first subset and the second subset.

16. The method of claim 15, further comprising:
formatting the first transaction message in a first format addressed to the first distinct host service provider; and
formatting the second transaction message in a second format addressed to the second distinct host service provider.

17. The method of claim 15, further comprising:
receiving a plurality of sets of data each identifying a part of the transaction data to be collected by the point-of-sale device; and
consolidating information from the received sets to produce the set of configuration data.

18. The method of claim 15, further comprising:
receiving, from the first distinct host service provider, a first set of data identifying information to be collected by the point-of sale device for the first distinct host service provider;
receiving, from the second distinct host service provider, a second set of data identifying information to be collected by the point-of-sale device for the second distinct host service provider,
wherein the set of configuration data comprises the first set of data and the second set of data.

19. The method of claim 18, further comprising:
identifying the first subset of the collected set of transaction data based at least in part on the received first set of data; and
identifying the second subset of the collected set of transaction data based at least in part on the received second set of data.

20. The method of claim 15, further comprising:
converting the first subset of the collected set of transaction data from a first format to a second format,
wherein the first transaction message encapsulates the first subset in the second format.

21. A system comprising:
a point-of-sale device configured to:
collect a set of transaction data specified by one or more received sets of data identifying types of data to be collected by the point-of-sale device; and
transmit the collected set of transaction data;
a server computer system, communicatively coupled with the point-of-sale device, and configured to:
receive routing information identifying types of transaction data to be routed to selected host service providers of a plurality of host service providers;
receive the collected set of transaction data;
automatically generate a first transaction message including a first subset of the collected set of transaction data for a first distinct host service provider, the first subset and the first distinct host service provider identified by the routing information;
transmit the first transaction message to the first distinct host service provider;
automatically generate a second transaction message including a second subset of the collected set of transaction data for a second distinct host service provider, the second subset and the second distinct host service provider identified by the routing information; and
transmit the second transaction message to the second host service provider.

22. The system of claim 21, further comprising:
the first distinct host service provider, communicatively coupled with the server computer system, and configured to transmit a first set of data identifying selected types of information to be collected by the point-of-sale device; and
the second distinct host service provider, communicatively coupled with the server computer system, and configured to transmit a second set of data identifying selected types of information to be collected by the point-of-sale device,
wherein the routing information includes the first set of data and the second set of data.
